(19) United States
(12) Patent Application Publication
(10) Pub. No.: US 2015/0248563 A1
(43) Pub. Date: Sep. 3, 2015

(54) REQUESTING INSTANT MESSAGING HISTORY BY VALIDATED PARTIES

(71) Applicant: International Business Machines Corporation, Armonk, NY (US)

(72) Inventors: Luca Alfarano, Dublin (IE); Judith H. Bank, Cary, NC (US); Patrick J. O'Sullivan, Dublin (IE)

(73) Assignee: International Business Machines Corporation, Armonk, NY (US)

(21) Appl. No.: 14/195,085

(22) Filed: Mar. 3, 2014

(51) Int. Cl. G06F 21/62; H04L 12/58

(52) U.S. Cl. CPC G06F 21/62; H04L 51/16

(57) ABSTRACT

Chat transcripts are requested by a requesting device by performing the following steps (not necessarily in the following order): (i) recording, by a first user's device, multiple chat transcripts respectively memorializing a plurality of online chats in which the first user's device participated; (ii) storing the chat transcript in a data storage device; (iii) receiving, by the data storage device through a communication network from a requesting device, a machine readable request for a copy of a set of chat transcript(s) from among the multiple chat transcripts; and (iv) responsive to receipt of the machine readable request for a copy, sending, by the data storage device, through the communication network to the requesting device, a copy of the chat transcript(s) corresponding to the requested set of chat transcript(s). The sending of the copy is performed automatically by machine logic and without substantial human intervention.

### BACKGROUND OF THE INVENTION

The present invention relates generally to the field of instant messaging type communications made over a communication network, and more particularly to requests for instant messaging transcripts (for example, transcript requests made for legal reasons). Instant messaging (IM) is a type of online chat which offers real-time text transmission over the internet. Short messages are typically transmitted bi-directionally between two or more mutually remote parties. The parties type text messages to each other with very little delay between the “sending” of a typed message by a party and its receipt by remote parties in a chat.

Instant messaging has lead to a set of communication technologies used for text-based communication between two or more participants over the internet or other types of networks. IM chat happens in “real-time.” Online chat, such as instant messaging, differs from other technologies, such as email, due to the typically small latency between successive communications by the users. Some systems permit messages to be sent to users not currently ‘logged on’ (offline messages), in which case the message is converted to an email, or something akin to an email. Sometimes people have conversations which reflect or suggest criminal activity. Sometimes these conversations take place through online chat. On some occasions, law enforcement agencies have requested (for example, by subpoena) transcripts of online chat sessions.

### SUMMARY

According to an aspect of the present invention, there is a method of communicating a chat transcript generated and saved in connection through a chat account having an associated chat account holder and an associated chat services provider entity. The method includes the following steps (not necessarily in the following order): (i) determining a set of valid request rule(s); (ii) receiving, from a requesting party's device and over a communication network, a request for a first chat transcript; (iii) determining whether the request meets any applicable valid request rules of the set of valid request rules; and (iv) responsive to a determination that the request meets any applicable valid request rules of the set of valid request rules, sending the chat transcript, over the communication network, to the requesting party's device. The requesting party is not either of the following: (i) the chat account holder, and (ii) a representative of the chat services provider entity. The determination of whether the request meets any applicable valid request rules is performed automatically and without substantial human intervention on the part of either of the following: (i) the chat account holder, and (ii) a representative of the chat services provider entity.

### BRIEF DESCRIPTION OF THE SEVERAL VIEWS OF THE DRAWINGS

FIG. 1 is a schematic view of a first embodiment of a networked computer system according to the present invention;

FIG. 2 is a flowchart showing a first method according to an embodiment of the present invention;

FIG. 3 is a schematic view of a portion of the first embodiment computer system;

FIG. 4A is a flowchart showing a first portion of a second method according to an embodiment of the present invention; and

FIG. 4B is a flowchart showing a second portion of the second method according to an embodiment of the present invention.

### DETAILED DESCRIPTION

In some embodiments of the present invention, a chat transcript, which has been stored in connection with a first chat account, is remotely requested by a requesting party other than an “authorized access party” (see definition in Definitions sub-section) with respect to the first chat account. It is determined, by software applying a set of requesting rule(s), whether the requesting party is a “valid requesting party” (see definition in Definitions sub-section). If the requesting party is a valid requesting party under the set of requesting rule(s), then the requested chat transcript is returned to the requestor, automatically and substantially without human intervention. In some embodiments, the set of requesting rule(s) will determine that any party to the chat memorialized in the requested chat transcript is a valid requesting party. In some embodiments: (i) the first chat account is the account of a first individual user; (ii) the first individual user uses a smart phone owned by her employer to engage in the chat of the requested chat transcript (without making the employer an authorized access party on the first chat account); and (iii) the set of requesting rule(s) will determine that the employer of the first individual user is a valid requesting party.

This Detailed Description section is divided into the following sub-sections: (i) The Hardware and Software Environment; (ii) Example Embodiment; (iii) Further Comments and/or Embodiments; and (iv) Definitions.

I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

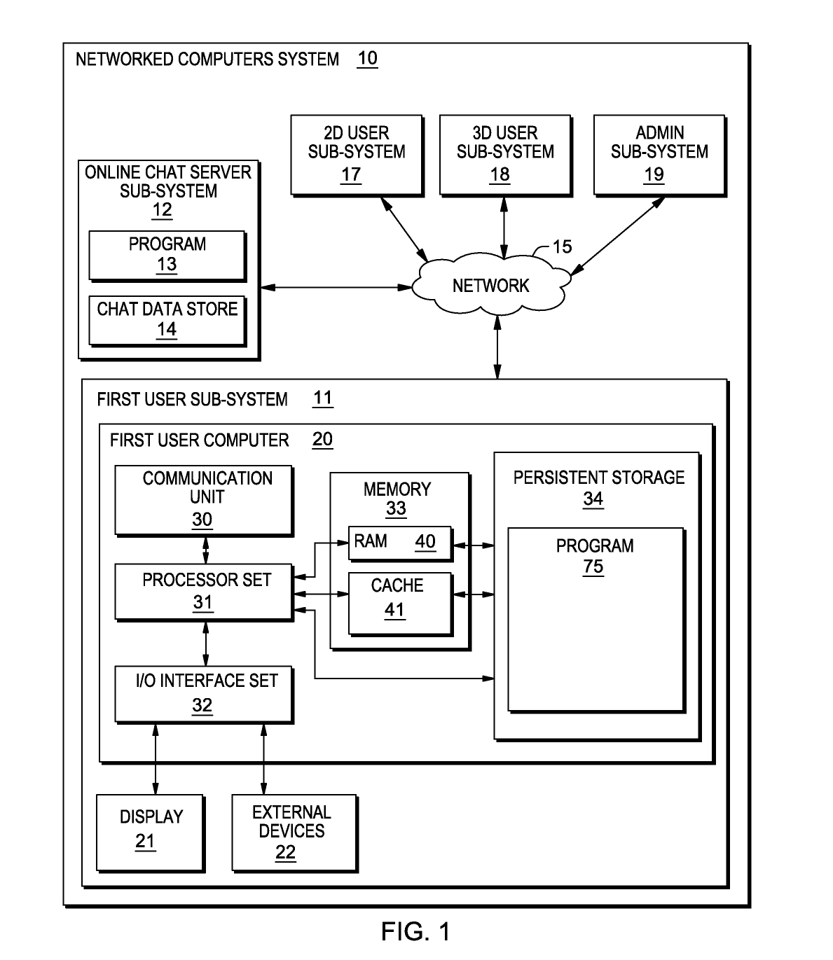

An embodiment of a possible hardware and software environment for software and/or methods according to the present invention will now be described in detail with reference to the Figures. FIG. 1 is a functional block diagram illustrating various portions of a networked computers system 10, including: first user sub-system 11; online chat server sub-system 12; program 13; chat data storage 14; 2D user sub-system 17; 3D user sub-system 18; admin sub-system 19; communication network 15; first user computer 20; communication unit 30; processor set 31; input/output (i/o) interface set 32; memory device 33; persistent storage device 34; display device 21; external device set 22; random access memory (RAM) devices 40; cache memory device 41; and program 75.

Sub-system 11 is, in many respects, representative of the various computer sub-system(s) in the present invention. Accordingly, several portions of sub-system 11 will now be discussed in the following paragraphs.

Sub-system 11 may be a laptop computer, tablet computer, netbook computer, personal computer (PC), a desktop computer, a personal digital assistant (PDA), a smart phone, or any programmable electronic device capable of communicating with the client sub-systems via network 15. Program 75 is a collection of machine readable instructions and/or data that is used to create, manage and control certain software functions that will be discussed in detail, below, in the Example Embodiment sub-section of this Detailed Description section.

Sub-system 11 is capable of communicating with other computer sub-systems via network 15. Network 15 can be, for example, a local area network (LAN), a wide area network (WAN) such as the Internet, or a combination of the two, and can include wired, wireless, or fiber optic connections. In general, network 15 can be any combination of connections and protocols that will support communications between server and client sub-systems.

Sub-system 11 is shown as a block diagram with many double arrows. These double arrows (no separate reference numerals) represent a communications fabric, which provides communications between various components of sub-system 11. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 33 and persistent storage 34 are computer-readable storage media. In general, memory 33 can include any suitable volatile or non-volatile computer-readable storage media. It is further noted that, now and/or in the near future: (i) external device(s) 22 may be able to supply, some or all, memory for sub-system 11; and/or (ii) devices external to sub-system 11 may be able to provide memory for sub-system 11.

Program 75 is stored in persistent storage 34 for access and/or execution by one or more of the respective computer processors 31, usually through one or more memories of memory 33. Persistent storage 34: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 34.

Program 75 may include both machine readable and performable instructions and/or substantive data (that is, the type of data stored in a database). In this particular embodiment, persistent storage 34 includes a magnetic hard disk drive. To name some possible variations, persistent storage 34 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 34 may also be removable. For example, a removable hard drive may be used for persistent storage 34. Other examples include optical and magnetic disks, thumb drives, and smart cards that are inserted into a drive for transfer onto another computer-readable storage medium that is also part of persistent storage 34.

Communications unit 30, in these examples, provides for communications with other data processing systems or devices external to sub-system 11. In these examples, communications unit 30 includes one or more network interface cards. Communications unit 30 may provide communications through the use of either or both physical and wireless communications links. Any software modules discussed herein may be downloaded to a persistent storage device (such as persistent storage device 34) through a communications unit (such as communications unit 30).

I/O interface set 32 allows for input and output of data with other devices that may be connected locally in data communication with first user computer 20. For example, I/O interface set 32 provides a connection to external device set 22. External device set 22 will typically include devices such as a keyboard, keypad, a touch screen, and/or some other suitable input device. External device set 22 can also include portable computer-readable storage media such as, for example, thumb drives, portable optical or magnetic disks, and memory cards. Software and data used to practice embodiments of the present invention, for example, program 75, can be stored on such portable computer-readable storage media. In these embodiments the relevant software may (or may not) be loaded, in whole or in part, onto persistent storage device 34 via I/O interface set 32. I/O interface set 32 also connects in data communication with display device 21.

Display device 21 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

II. Example Embodiment

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

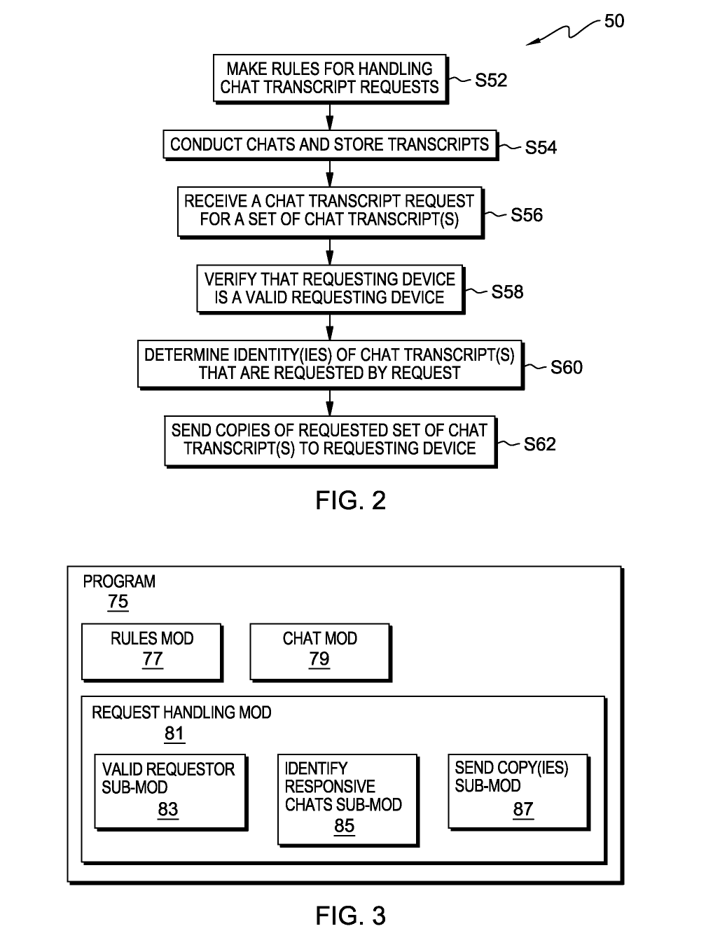

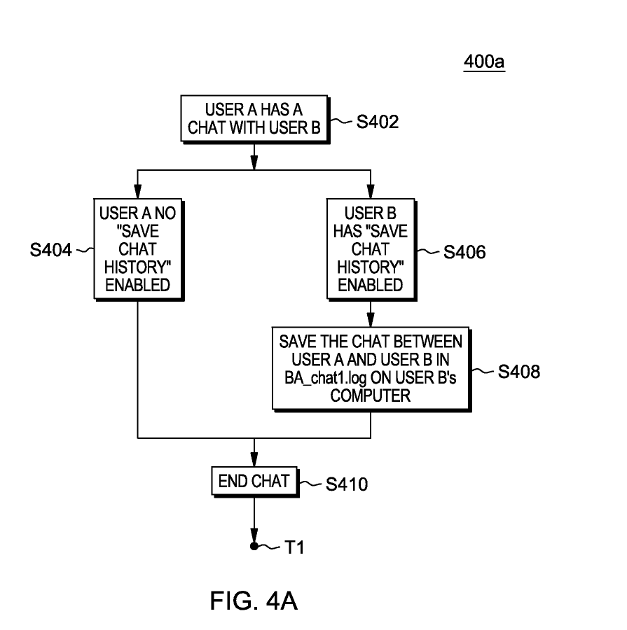

FIG. 2 shows flow chart 50 depicting a method according to the present invention. FIG. 3 shows program 75 for performing at least some of the method steps of flow chart 50. This method and associated software will now be discussed, over the course of the following paragraphs, with extensive reference to FIG. 2 (for the method step blocks) and FIG. 3 (for the software blocks).

Processing begins at step S52, where rules module (“mod”) 77 of program 75 makes rules for handling chat transcript requests that may later be received by first user sub-system 11 and/or its remote data storage device, online chat server sub-system 12 (see FIG. 1). In this embodiment, these rules will later be applied to chat transcript requests by first user sub-system 11. Alternatively or additionally, in other embodiments, these rules are sent to program 13 of online chat server sub-system 12 so that program 13 can later apply these rules against various incoming requests for chat transcripts made by various third parties.

More specifically, in conventional chat systems certain parties can locally and/or remotely access stored chat transcripts. These “authorized access parties” (see definition, below) typically include: (i) the account holder(s); and (ii) the chat service provider entity. The rules of rules mod 77 are not generally concerned with selectively allowing access to chat transcripts by authorized access parties. While the embodiment of system 10 does allow authorized access parties (in this example, the first user and the entity that owns and controls online chat server sub-system 12) to access chat transcripts: (i) this is done in the conventional way; and (ii) rules mod 77 is not involved in this aspect of operations. Rather, rules mod 77 makes the rules for “valid requesting parties” (see definition, below). These valid requesting parties are not authorized access parties, but are allowed to remotely request, and receive, chat transcripts anyway, usually in limited circumstances as will be explained in more detail, below.

Processing proceeds to step S54, where chat mod 79 of program 75: (i) conducts chats, co-operatively with other end user devices (such as second user sub-system 17 and third user sub-system 18, in which first user sub-system 11 participates; and (ii) stores chat transcripts of all chats in which first user sub-system 11 participates. In this example, the chat transcripts are not stored locally, but are stored remotely at chat data store 14 of online chat server sub-system 12 (see FIG. 1). This conducting of chats and management of remote storage of chats is performed as is currently conventional.

Processing proceeds to step S56, where request handling mod 81 receives a chat transcript request through network 15 (see FIG. 1). In this example, the request originates from admin sub-system 19. The admin who uses sub-system 19 to communicate over network 15 does not administer the chat software (such as chat mod 79) and chat system used by the first user. Rather, the admin of sub-system 19 is an admin working for the same employer entity that employs the first user, which employment entity has allowed the first user the use of the computer hardware (and some of the computer software) making up first user sub-system 11. This employer does not object that first user sub-system is being used by the first user to participate in chats which are administered by the entity that controls online chat sub-system 12, but the employer does want the ability to remotely collect any chat transcripts in which the first user participated by using first user sub-system 11. More specifically, in this example, the employer believes that it needs this ability to efficiently and effectively respond to subpoena requests that it occasionally gets from courts of various state and/or national jurisdictions.

In this example, the employer has received a subpoena from the high court of the nation where the first user lives, works and chats through sub-system 11. This subpoena asks for all employee communications made between noon and one o′clock on the previous Friday. This is why admin sub-system 19 is making a request for all of the first user's chat transcripts made between noon and one o′clock on the previous Friday. Alternatively, admin sub-system 19 might make the request with other timing and/or subject matter delimiters (or with no delimiters, a “blanket request”). As a further alternative, the party making the request might be the second user of second user sub-system 17, who is the first user's spouse. As a further alternative, the requesting party might be the third user of third user sub-system 18, who is a frequent chat partner of the first user, but who has the annoying habit of failing to save his chat transcripts. There may be many and various situations where a chat account holder wants certain other parties to be “valid requesting parties,” at least in certain circumstances.

Processing proceeds to step S58, where valid requestor sub-mod 83 applies the rules developed at step S52 in order to determine if the request, received at step S56, has: (i) been received through the device of a valid requesting party; and (ii) meets any other applicable rules set by rules mod 77 in step S52. In this example, the admin of admin sub-system 19 is indeed a valid requesting party, but there is a rule in rules mod 77 that specifies that the employer's representative must email a copy of the subpoena if the request is being made pursuant to a subpoena. Accordingly, in this example, the machine logic of sub-mod 83 sends a message back to admin sub-system 19 to inquire whether the request is pursuant to a subpoena. The admin responds that the request is indeed pursuant to a subpoena. Accordingly, in this example, the machine logic of sub-mod 83 sends a message back to admin sub-system 19 to request that a scanned copy of the subpoena be sent to online chat server sub-system 12 so that this subpoena can later be audited and/or supplied to the first user (as may be appropriate). In response, the admin emails the subpoena, and program 13 of online chat server sub-system 12 communicates receipt of the email to valid requestor sub-mod 83 of request handling mod 81 of program 75 of first user sub-system 11 so that sub-mod 83 determines that the rules applicable to the request made at step S56 have been met.

Processing proceeds to step S60, where identify responsive chats sub-mod 85 queries program 13 and chat data store 14 of online chat server sub-system 12 in order to determine which chat transcript(s) are responsive to the pending request. In some cases, the requested chat will be fully identified by the requestor, including an identification of date, time and chat participants. In other cases, the request may be a request for transcripts of all chats related to a keyword, or all chats that involve a certain party. In this example, the admin is requesting transcripts for all chats in which the first user participated through first user sub-system 11 on last Friday between noon and one o′clock. This means that sub-mod 85 will work co-operatively with program 13 and chat data store 14 of online chat server sub-system in order to identify all chat transcripts remotely stored at chat data store 14 of online chat server sub-system 12 that meet the timing and participant conditions set forth above.

Processing proceeds to step S62, where send copy(ies) sub-mod 87 directs that the responsive chat transcripts, identified at step S60, from their storage location(s) (in this example, data store 14) back to the requestor (in this example, admin sub-system 19).

III. Further Comments and/or Embodiments

Some embodiments of the present invention recognize the following facts, potential problems and/or potential areas for improvement with respect to the current state of the art: (i) criminal suspects may delete some damaging conversations from their chat histories; (ii) criminal suspects may remove compromising contacts from a buddy list; (iii) criminal suspects may use an instant messaging system different from the corporate system; and/or (iv) criminal suspects may hide the proof that could link other people, or other companies, to their suspected illicit activities.

Some embodiments of the present invention may include one, or more, of the following characteristics, features and/or advantages: (i) authorized parties have the ability to request (or “subpoena,” as used herein “subpoena” means any request for information, whether or not the request is made for legal purposes), all the IM messages sent and received by a target party and contact(s) of the target party; (ii) requests may be limited to a specified time range; (iii) responses to subpoenas may cover messages generated from different IM communities; (iv) the ability to issue a subpoena for all the common chat history for a specific contact; (v) the chat history returned, in response to a subpoena, is the history of all the conversations the contact had with the user (this may be limited to a specified time range); (vi) return of the chat history stored locally in the contact's computer or remotely on the domain's server; and/or (vii) return of chat history regardless of the IM system used; and (viii) ability to issue a subpoena limited to specific topics and/or keywords.

Some embodiments of the present disclosure may further include one, or more, of the following features, characteristics, and/or advantages: (i) the requesting party (for example, country) executing the subpoena can re-generate a list of potential consultant's contacts; (ii) the country executing the subpoena could request a chat history for all of the target party's contacts, thus extending the range of potentially compromising conversations; (iii) reduce the risk that the target party can delete his IM traces/conversations from the IM's servers; (iv) in the event of a computer crash and/or the accidental or unwanted loss of data, the ability to restore a chat history record; (v) easy access to the same users account from a different computer for the purpose of rebuilding the local chat history without the need to store it on a separate server; (vi) the ability for one user to subpoena history from another user directly (at least where corporate retention policies are not violated and support this type of activity); and/or (vii) ability for a user to request his own history. Further with regard to item (vii), when a user requests his own history, this may be limited in various ways, such as the following: (a) request specific to another user; (b) request specific to one or more IM domains; and/or (c) request a specific time range, such as last year, ten (10) years ago, between June and July 2010, etc.

Some embodiments of the current disclosure respond to requests in at least one of two ways as follows: (i) requests go to the various clients solicited and there is a handshake, or series of handshakes, from which the responses are returned; and/or (ii) the remote user's server, that stores online chat data, responds to a request. Further with respect to item (ii), the server to which the request is made may communicate with other servers (for example, online chat servers) to respond to the request. When the request is satisfied, the history is replicated on the requesting side remotely or locally, depending on configuration.

Some embodiments of the present invention may include one, or more, of the following characteristics, features and/or advantages: (i) the contact list could be extended/re-generated merging the users email address book, social network, and/or personal contacts; (ii) the subpoena could refer exclusively to the chat conversation that matches specific keywords; and (iii) the subpoena could also be issued to any contact, but only returns results in cases where: (a) the two contacts attended the same conversation(s), and (b) the data resides on the domain server of the contact, either locally or remotely.

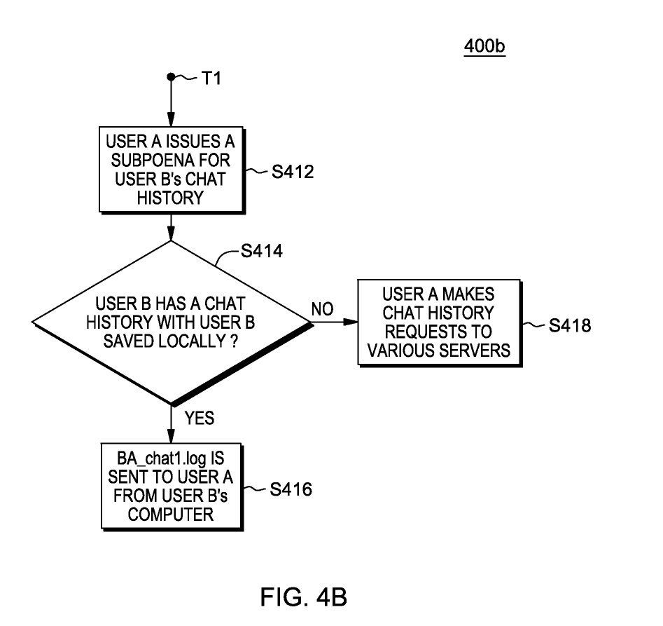

As shown in FIGS. 4A and 4B, process 400 (with first portion 400a shown in FIG. 4A and second portion 400b shown in FIG. 4B) is a method that can be used when an online chat User A has not been saving his chat transcripts through his online chat account, but then later wants to obtain at least some of his chat history that he has had with User B.

As shown in FIG. 4A, processing begins at step S402, where User A starts an online chat with User B using an IM system. In step S404, User A does not have the SCH (save chat history) feature of his IM enabled, so after closing the chat window the conversation won't be available on his computer. In step S406, also during the real time online chat, User B has the SCH feature of his IM enabled. In step S408, after closing his chat window the entire conversation User B had with User A will be saved locally in a file, BA_chat1.log, on the Users B's computer. In step S410, User A and User B close their chat windows. User A doesn't have any trace of the conversation on his computer, while User B′s device has a saved file that includes the transcript and metadata.

Processing proceeds to step S412 (see FIG. 4B at terminal T1), where User A issues a subpoena to User B for the mutual chat history they have had. Processing proceeds to step S414, where the system checks if User B has any chat saved with User A, by locating the BA_chat1.log. In step S416, the BA_chat1.log is sent from the IM system to User A, where the data now becomes part of User A's chat history stored on User A's device. If User B does not have the chat history, then processing proceeds to step S418 where User A's device makes requests to various servers, to attempt to recover the chat transcript.

Some embodiments of the present disclosure may further include one, or more, of the following features, characteristics, and/or advantages: (i) application of instant messaging history on every instant messaging system; (ii) users ability to issue a conversation history subpoena for any instant message chat they directly attended; (iii) manage and configure inbound access list, for chat history subpoena requests, for users on their buddy list, or from specific users; (iv) manage and configure outbound subpoena requests for chat history, where approval is required or not required; (v) issue a subpoena for any user's conversation history for a specific authorized user; (vi) generate or re-generate a user contact list, for issuing chat history subpoenas, by merging/cross referencing email, address book, social network and/or personal contacts; (vii) compare chats (by subject, time, and/or date) from a single and/or multiple participant(s) to identify altered chat histories; and (viii) issue a subpoena for all conversations that match a particular keyword(s) or key phrase.

Some embodiments of the present disclosure may further include one, or more, of the following features, characteristics, and/or advantages: (i) audit/governance of instant messaging history in which a user, or authorized authority, is allowed to interrogate the organization grid of IM transcripts to subpoena evidence from one or more elements of the grid; (ii) subpoenaing can be performed from any point in the grid to any other point(s) in the superset grid; (iii) cater for a distributed pan geographic server, in which multiple IM servers, can be horizontally or vertically clustered and inter-federated; and (iv) duplicate a part of a user's local chat history on the other participant's device when requested (as opposed to retrieving chat history as a routine matter for synchronization purposes).

IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Software storage device: any device (or set of devices) capable of storing computer code in a manner less transient than a signal in transit.

Tangible medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Chat transcript: includes entire chat transcripts and/or portions of chat transcript; for example, if an embodiment of the present invention, in response to a request for a chat transcript, sent back only a portion of the chat transcript, then that will be considered as “sending back the chat transcript,” notwithstanding the fact that only a portion is sent back.

Without substantial human intervention: if a user has to approve that her device sends a copy of a chat transcript, then this is not considered to be “substantial human intervention,” however, if the user has to find the transcript file in a file directory system, type the requester's telephone number in to send back the chat transcript, or perform similar attention intensive activities, then this would involve “substantial human intervention” as that phrase is hereby defined.

Authorized access party: Any party normally given access to a certain set of chat transcripts in a conventional chat account; conventionally, “authorized access parties” are limited to the individual holder(s) of the chat account and the administrating entity for the chat account.

Valid requesting party: a party that is not an authorized access party, but whom is allowed remote access to chat transcripts under the terms set by a set of machine-logic-applied requesting rules; for example, the requesting rules may allow any party that participated in a chat to later access that chat transcript without the need for an authorized access party to supply the chat transcript.

Request for a transcript: does not need to fully specify the transcript, but, rather, may take the form of a request for any and all chat transcripts that meet certain conditions (such as temporal delimiters, participating party delimiters).

Instant messaging (IM) community: essentially a group: for example, Company A employees are members of the Company A IM community, and Company B employees are members of the Company B IM community; there may also be private IM communities that are constituted by a small number of individuals, and where these individuals belong to the private IM community despite the fact that the IM community has not been created by, and is not administered by, the individuals' respective employers.

What is claimed is:

1. A method of communicating a chat transcript generated and saved in connection through a chat account having an associated chat account holder and an associated chat services provider entity, the method comprising:
determining a set of valid request rule(s);
receiving, from a requesting party's device and over a communication network, a request for a first chat transcript;
determining whether the request meets any applicable valid request rules of the set of valid request rules; and
responsive to a determination that the request meets any applicable valid request rules of the set of valid request rules, sending the chat transcript, over the communication network, to the requesting party's device;
wherein:
the requesting party is not either of the following: (i) the chat account holder, and (ii) a representative of the chat services provider entity; and
the determination of whether the request meets any applicable valid request rules is performed automatically and without substantial human intervention on the part of either of the following: (i) the chat account holder, and (ii) a representative of the chat services provider entity.

2. The method of claim 1 wherein:
the set of valid request rule(s) includes a subset of valid requesting party rule(s); and
the determination of whether the request meets any applicable valid request rules of the set of valid request rules includes a determination, based, at least in part on an identity of the requesting party, of whether the requesting party meets any applicable valid requesting party rule(s).

3. The method of claim 2 wherein:
a first valid request rule is that a party who has participated in at least one chat with the chat account holder is a valid requesting party; and
a second valid request rule is that a party that is a given valid requesting party that has valid requesting party status only on the basis of meeting the first valid request rule may only be sent chat transcripts in which the given valid requesting party had participated.

4. The method of claim 2 wherein:
a first valid request rule is that a party who employs the chat account holder and provides hardware through which the chat account holder participates in chats is a valid requesting party.

5. The method of claim 1 wherein:
the chat account is part of a first instant messaging community; and
the requesting party does not belong to the first instant messaging community.

6. A computer program product for communicating a chat transcript generated and saved in connection through a chat account having an associated chat account holder and an associated chat services provider entity, the computer program product comprising software stored on a software storage device, the software comprising:
first program instructions programmed to determine a set of valid request rule(s);
second program instructions programmed to receive, from a requesting party's device and over a communication network, a request for a first chat transcript;
third program instructions programmed to determine whether the request meets any applicable valid request rules of the set of valid request rules; and
fourth program instructions programmed to, responsive to a determination that the request meets any applicable valid request rules of the set of valid request rules, send the chat transcript, over the communication network, to the requesting party's device;
wherein:
the requesting party is not either of the following: (i) the chat account holder, and (ii) a representative of the chat services provider entity;
the determination of whether the request meets any applicable valid request rules is performed automatically and without substantial human intervention on the part of either of the following: (i) the chat account holder, and (ii) a representative of the chat services provider entity; and
the software is stored on a software storage device in a manner less transitory than a signal in transit.

7. The product of claim 6 wherein:
the set of valid request rule(s) includes a subset of valid requesting party rule(s); and
the determination of whether the request meets any applicable valid request rules of the set of valid request rules includes a determination, based, at least in part on an identity of the requesting party, of whether the requesting party meets any applicable valid requesting party rule(s).

8. The product of claim 7 wherein:
a first valid request rule is that a party who has participated in at least one chat with the chat account holder is a valid requesting party; and
a second valid request rule is that a party that is a given valid requesting party that has valid requesting party status only on the basis of meeting the first valid request rule may only be sent chat transcripts in which the given valid requesting party had participated.

9. The product of claim 7 wherein:
a first valid request rule is that a party who employs the chat account holder and provides hardware through which the chat account holder participates in chats is a valid requesting party.

10. The product of claim 6 wherein:
the chat account is part of a first instant messaging community; and
the requesting party does not belong to the first instant messaging community.

11. A computer system for communicating a chat transcript generated and saved in connection through a chat account having an associated chat account holder and an associated chat services provider entity, the computer system comprising:
a processor(s) set; and
a software storage device;
wherein:
the processor set is structured, located, connected and/or programmed to run software stored on the software storage device; and
the software comprises:
first program instructions programmed to determine a set of valid request rule(s);
second program instructions programmed to receive, from a requesting party's device and over a communication network, a request for a first chat transcript;
third program instructions programmed to determine whether the request meets any applicable valid request rules of the set of valid request rules; and
fourth program instructions programmed to, responsive to a determination that the request meets any applicable valid request rules of the set of valid request rules, send the chat transcript, over the communication network, to the requesting party's device;
wherein:
the requesting party is not either of the following: (i) the chat account holder, and (ii) a representative of the chat services provider entity;
the determination of whether the request meets any applicable valid request rules is performed automatically and without substantial human intervention on the part of either of the following: (i) the chat account holder, and (ii) a representative of the chat services provider entity; and
the software is stored on a software storage device in a manner less transitory than a signal in transit.

12. The system of claim 11 wherein:
the set of valid request rule(s) includes a subset of valid requesting party rule(s); and
the determination of whether the request meets any applicable valid request rules of the set of valid request rules includes a determination, based, at least in part on an identity of the requesting party, of whether the requesting party meets any applicable valid requesting party rule(s).

13. The system of claim 12 wherein:
a first valid request rule is that a party who has participated in at least one chat with the chat account holder is a valid requesting party; and
a second valid request rule is that a party that is a given valid requesting party that has valid requesting party status only on the basis of meeting the first valid request rule may only be sent chat transcripts in which the given valid requesting party had participated.

14. The system of claim 12 wherein:
a first valid request rule is that a party who employs the chat account holder and provides hardware through which the chat account holder participates in chats is a valid requesting party.

15. The system of claim 11 wherein:
the chat account is part of a first instant messaging community; and
the requesting party does not belong to the first instant messaging community.
